(19) United States
(12) Patent Application Publication
(10) Pub. No.: US 2015/0347515 A1
(43) Pub. Date: Dec. 3, 2015

(54) RULE-BASED, PREEMPTIVE DOWNLOAD OF DIGITAL MEDIA ASSETS

(71) Applicant: Apple Inc., Cupertino, CA (US)

(72) Inventors: James Howard Callender, San Francisco, CA (US); Cody Jorgensen, San Jose, CA (US); Edward T. Schmidt, Burlingame, CA (US)

(73) Assignee: Apple Inc., Cupertino, CA (US)

(21) Appl. No.: 14/292,373

(22) Filed: May 30, 2014

(51) Int. Cl. G06F 17/30

(52) U.S. Cl. CPC G06F 17/30507; G06F 17/30053; G06F 17/30864

(57) ABSTRACT

Rules are used to determine which digital media assets are to be downloaded from a digital media store preemptively to a client device. In some implementations, a client device receives a notification from the digital media store regarding an update to a remote digital media library. The rules are evaluated to determine which digital media assets are to be downloaded preemptively to the client device. Based on the evaluation of the rules, requests for the digital media assets that are to be stored locally and are not already stored locally are aggregated and sent to the digital media store. The digital media items are downloaded from the digital media store to the client device using, for example, a syncing service.

### TECHNICAL FIELD

This disclosure relates generally to mobile device management and online digital media stores.

### BACKGROUND

Online digital media stores allow users to purchase and download digital media assets over wired connection or over-the-air (OTA) using a variety of mobile devices (e.g., media players, smart phones, tablet computers, wearable computers). Because mobile devices have limited memory a digital media player running on the mobile device will use metadata to represent digital media assets in a local digital media library. The actual data for the digital media assets (e.g., audio files, video files) are stored “in the cloud” by the digital media store. A user can download the digital media asset data from the digital media store to their mobile device and store it in the local digital media library.

A user can search and browse the local digital media library to find and play digital media assets using the digital media player. Some digital media players offer a playlist feature that allows a user to create a playlist for digital media assets based on different criteria selected by the user.

### SUMMARY

Rules are used to determine which digital media assets are to be downloaded from a digital media store preemptively to a client device. In some implementations, a client device receives a notification from the digital media store regarding an update to a remote digital media library. The rules are evaluated to determine which digital media assets are to be downloaded preemptively to the client device. Based on the evaluation of the rules, requests for the digital media assets that are to be stored locally and are not already stored locally are aggregated and sent to the digital media store. The digital media items are downloaded from the digital media store to the client device using, for example, a syncing service.

In some implementations, a method comprises: receiving, by an electronic device, a notification from a digital media store regarding an update to a remote digital media library; evaluating rules for storing digital media asset data on the electronic device; determining, based on the evaluation of the rules, one or more digital media assets to be stored locally and are not stored locally; initiating a download of data for the digital media assets that are not stored locally; and storing the downloaded data on the electronic device.

Other implementations are directed to systems, devices and non-transitory, computer-readable storage mediums. Particular implementations disclosed herein provide one or more of the following advantages. Digital media assets are preemptively downloaded to a client device based on rules that indicate a user's preferences for which digital media items are to be stored locally. This feature saves the user time because the user does not have to manually specify a digital media asset to download and then wait for the download to complete.

The details of the disclosed implementations are set forth in the accompanying drawings and the description below. Other features, objects and advantages are apparent from the description, drawings and claims.

### DESCRIPTION OF DRAWINGS

FIG. 1 illustrates an operating environment for rule-based, preemptive download of digital media assets.

FIG. 2 illustrates a digital media player graphical user interface.

FIG. 3 is a flow diagram of example process for rule-based, preemptive download of digital media assets.

FIG. 4 is a block diagram of example client device architecture for implementing the features and processes described in reference to FIGS. 1-3.

FIG. 5 is a block diagram of example server computer architecture for implementing the features and processes described in reference to FIGS. 1-3.

The same reference symbol used in various drawings indicates like elements.

### DETAILED DESCRIPTION

### Example System

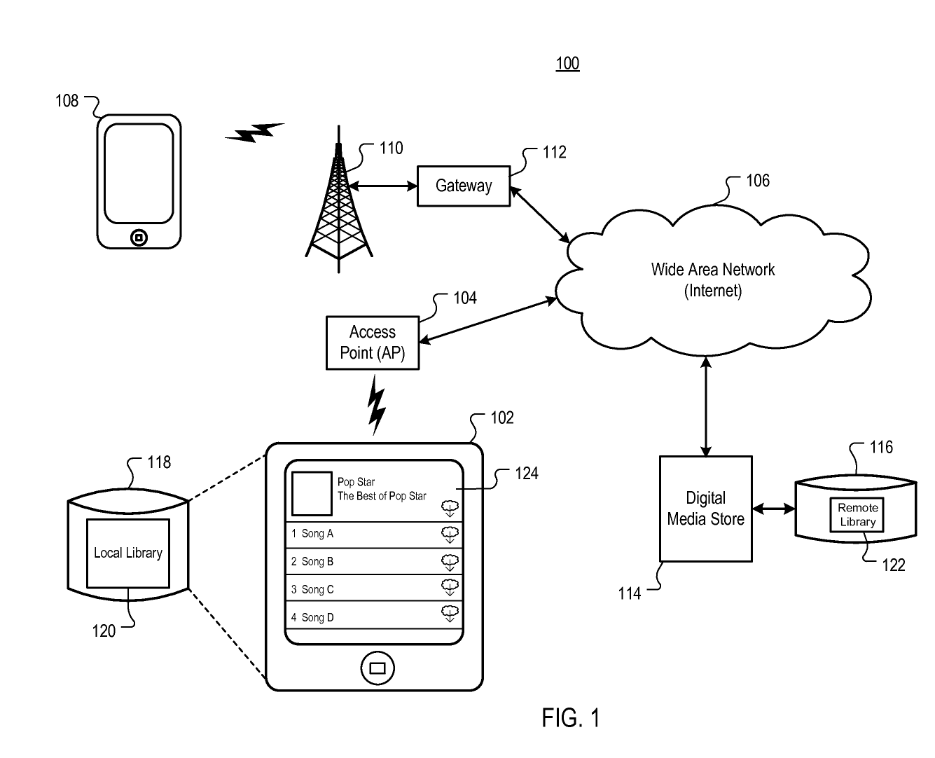

FIG. 1 illustrates an operating environment 100 for rule-based, preemptive download of digital media assets. In some implementations, operating environment 100 can include client device 102 coupled to wide area network 106 (e.g., the Internet) through access point (AP) 104. Alternatively, client device 108 can be coupled to network 106 through cell tower 110 and gateway 112. Digital media store 114 is coupled to wide area network 106 and database(s) 116.

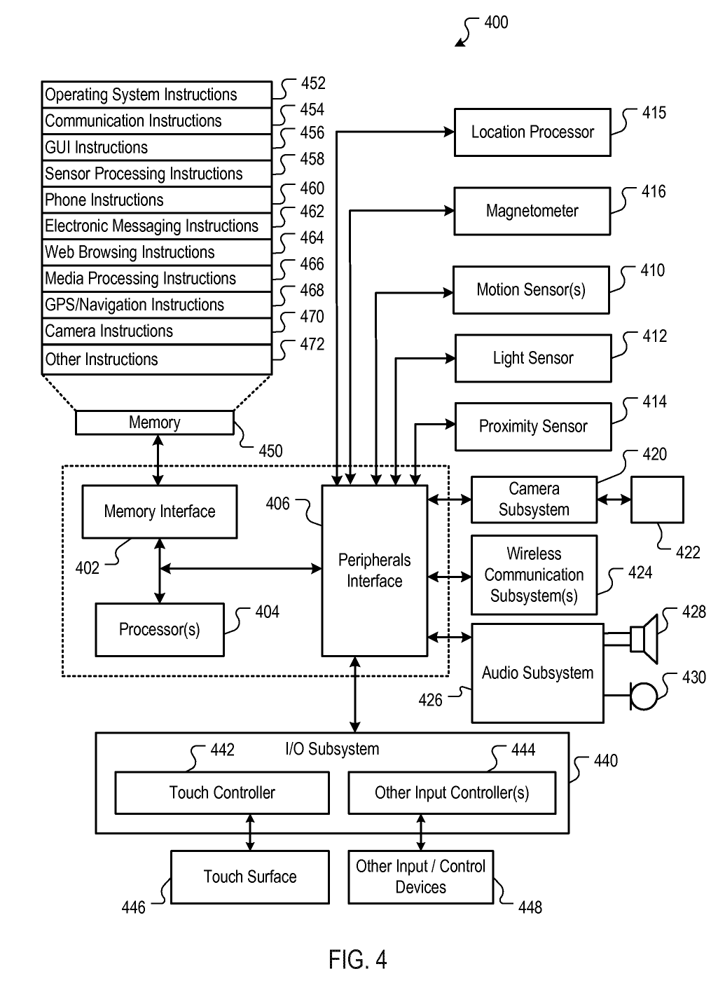

Client devices 102, 108 can be any device with network connectivity that can download digital media assets from digital media store 114, including but not limited to personal computers, smart phones, tablet computers and wearable computers. Client devices 102, 108 can have the architecture described in reference to FIG. 4. In the example shown, client device 102 includes storage device 118 (e.g., memory, disk drive) for storing local digital media library 120.

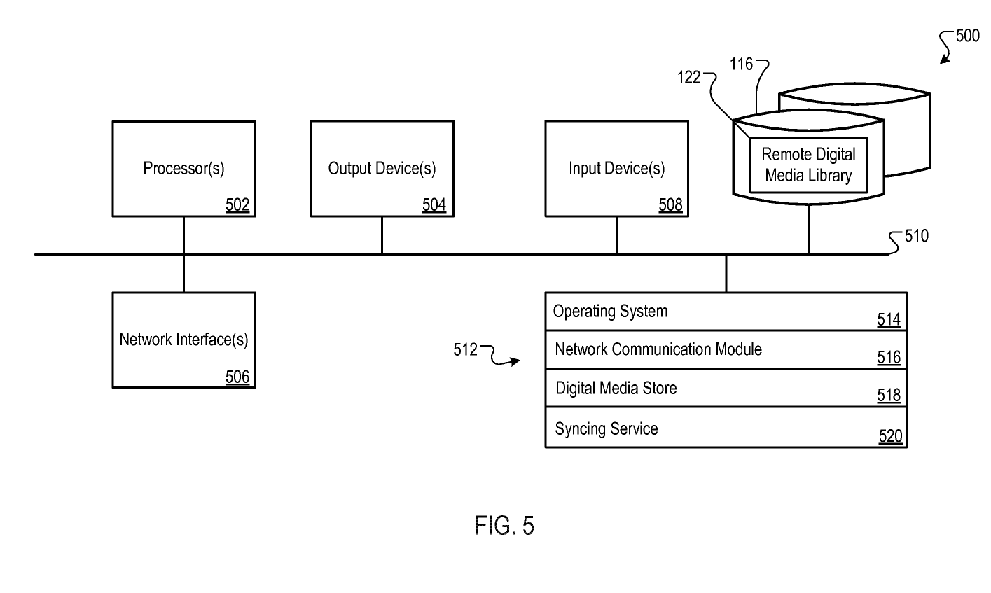

Digital media store 114 can be a digital media distribution platform that allows users to purchase and store digital media assets in remote digital media library 122. Digital media assets can include but are not limited to music, videos, e-books, applications, ringtones and any other digital content. Digital media store 114 can include one or more server computers each having the architecture described in reference to FIG. 5. An example digital media store 114 is the iTunes® Store operated by Apple Inc. (Cupertino, Calif.).

Database(s) 116 can be a distributed database system that includes multiple databases housed at different geographic locations. A user can have a personal remote digital media library 122 of their digital media assets stored in database(s) 116. In the example shown, a user of client device 102 can synchronize digital media assets stored in their local digital media library 120 with their remote digital media library 122. The user can purchase new digital media assets from digital media store 114 using client device 102. The user can browse and play digital media assets stored in local digital media library 120 using a media player application. The media player application can display a graphical user interface (GUI) 124, which allows the user to download digital media assets from their personal remote digital medial library 122.

The media player application allows the user to organize their digital media assets into containers, such as playlists. A playlist includes digital media assets, a title and other attributes defined by metadata. For example, a playlist can include an ordered list of songs for an album or artist. When the user plays the playlist in the media player each song is played in order according to the list or, if the user enabled a “shuffle” feature, in a random order. A user can create a variety of different types of playlists, including but not limited to playlists for artists, albums, recently purchased assets, most recently played assets, favorite assets, highest rated assets, most frequently played assets and any other category desired by the user. In some implementations, a playlist can be a “smart” playlist that includes digital media assets selected based on user-specified criteria. A smart playlist can be created as a one-off, unchangeable list, or can be made to change continuously (“live updating”).

Metadata for digital media assets included in the playlist can be viewed in GUI 124 of the media player application. Metadata can include but is not limited to title, artist, running time, genre, ratings and number of plays. Some of the digital media assets in a playlist are stored in storage device 118. Other digital media assets in the playlist are stored in database 116 of digital media store 114 and must be downloaded to client device 102 before the assets can be played by the media player application.

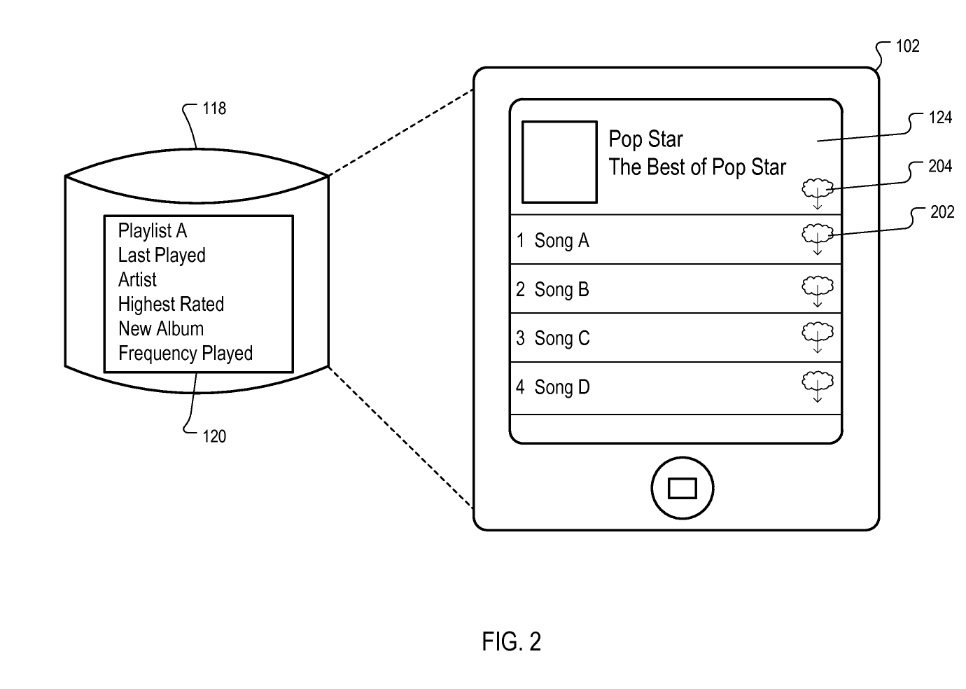

FIG. 2 illustrates a digital media player GUI. A media player application can present GUI 124 on a display screen of client device 102. In the example shown, a “New Album” playlist for Pop Start (“The Best of Pop Star”) is presented in GUI 124. The metadata needed to create the New Album playlist can be obtained from local digital media library 120. Since the album is new, none of the songs have been downloaded to device 102 and stored on storage device 118. The user can download each song individually from digital media store 114 by selecting an individual download button 202 in GUI 124 that corresponds to the song. Additionally, the user can select download button 204 to download all of the songs from Pop Star's new album. After the songs are downloaded, the songs can be played back by the media player application. The same song can appear in any number of playlists in local digital media library 120 that are created by the user or by the media player application. For example, songs in the New Album playlist for Pop Star can also appear in an “Artist” playlist or “Highest Rated” playlist for Pop Star. Each of the playlists in local digital media library 120 can have a counterpart playlist stored in remote digital media library 122.

### Example Process

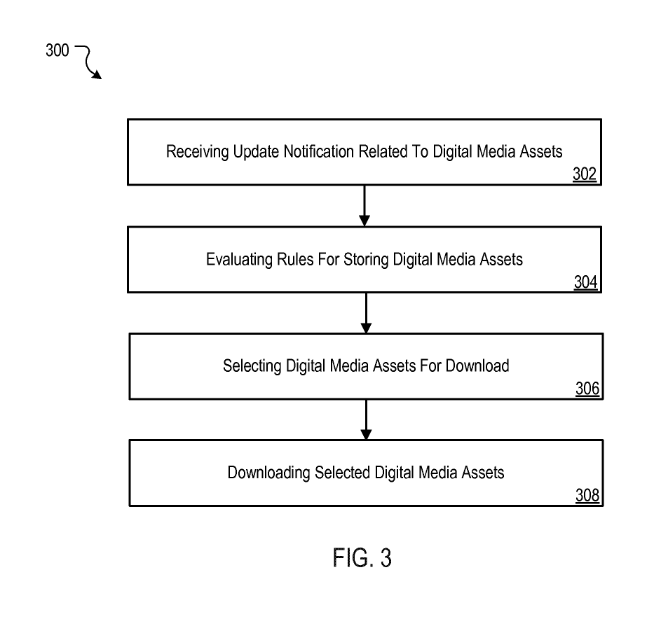

FIG. 3 is a flow diagram of example process 300 for rule-based, preemptive download of digital media assets. Process 300 can be implemented using the architecture described in reference to FIG. 4.

In some implementations, process 300 can begin on a client device when a media player application running on the client device receives an update notification (302) from a digital media store indicating that a change has been made to a remote digital media library. An example update notification can indicate, for example, the addition of a new digital media asset to the remote digital media library (e.g., a new purchase).

Process 300 continues on the client device by evaluating rules (304) describing which digital media assets should be stored locally on the client device. Because of the limited storage space of the client device, the local digital media library will typically store only metadata for the digital media assets, which can be used by the media player application to display the titles and other attributes of the digital media assets in a GUI. The rules can include the identification of playlists and other containers that include digital media assets that should be stored locally, presumably because such digital media assets are played back often by the user.

For example, a rule may specify that all the digital media assets (e.g., songs) of a given artist be stored locally. A rule may specify that all digital media assets in a user's favorite list or most frequently played list be stored locally. In some implementations, a user can mark individual playlists or digital media assets to be stored locally. For example, the user can check a “store locally” box next to each digital media asset in a playlist or a check box for the entire playlist to indicate that the checked asset or checked playlist (all assets in the playlist) is to be stored locally. In other implementations, digital media assets are selected automatically to be stored locally by the media player application or a client operating system. For example, if the user selects button 206 (FIG. 2) to download all the digital media assets for a new album, a rule can be created automatically that all the digital media assets for the new album are to be stored locally.

Process 300 can continue by selecting digital media assets to be downloaded preemptively (306). In this context, “preemptively” means downloading a digital media asset to a client device automatically based on rules rather than in response to a request by a user. After the rules are evaluated the media application determines which of the digital media assets that are to be stored locally are already stored locally. Request for the digital media assets that are not stored locally are aggregated into a request queue to be sent in a syncing request to the digital media store. A syncing service at the digital media store synchronizes the local and remote digital media libraries, which results in the digital media assets in the request queue being downloaded (308) to and stored on the client device. Once downloaded, the user can play back the digital media assets using the media player application.

Process 300 described above can repeated each time an update notification is received from the digital media store until the user intentionally deletes the digital media asset from the client device or otherwise indicates (e.g., uncheck a store locally box) that the digital media asset is not to be stored locally.

### Example Client Architecture

FIG. 4 is a block diagram of example architecture for the client devices 104 described in reference to FIGS. 1-3. Architecture 400 may be implemented on a mobile device for implementing the features and processes described in reference to FIGS. 1-3, including but not limited to portable computers, smart phones, tablet computers, game consoles, wearable computers and the like. Architecture 400 may include memory interface 402, data processor(s), image processor(s) or central processing unit(s) 404, and peripherals interface 406. Memory interface 402, processor(s) 404 or peripherals interface 406 may be separate components or may be integrated in one or more integrated circuits. One or more communication buses or signal lines may couple the various components.

Sensors, devices, and subsystems may be coupled to peripherals interface 406 to facilitate multiple functionalities. For example, motion sensor 410, light sensor 412, and proximity sensor 414 may be coupled to peripherals interface 406 to facilitate orientation, lighting, and proximity functions of the device. For example, in some implementations, light sensor 412 may be utilized to facilitate adjusting the brightness of touch surface 446. In some implementations, motion sensor 410 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 406, such as a temperature sensor, a biometric sensor, or other sensing device, to facilitate related functionalities.

Location processor 415 (e.g., GPS receiver chip) may be connected to peripherals interface 406 to provide geo-referencing. Electronic magnetometer 416 (e.g., an integrated circuit chip) may also be connected to peripherals interface 406 to provide data that may be used to determine the direction of magnetic North. Thus, electronic magnetometer 416 may be used with an electronic compass application.

Camera subsystem 420 and an optical sensor 422, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 424. Communication subsystem(s) 424 may include one or more wireless communication subsystems. Wireless communication subsystems 424 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 424 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., WiFi, WiMax), code division multiple access (CDMA) networks, NFC and a Bluetooth™ network. Wireless communication subsystems 424 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 426 may be coupled to a speaker 428 and one or more microphones 430 to facilitate voice-enabled functions, such as voice recognition, voice replication, digital recording, and telephony functions.

I/O subsystem 440 may include touch controller 442 and/or other input controller(s) 444. Touch controller 442 may be coupled to a touch surface 446. Touch surface 446 and touch controller 442 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 446. In one implementation, touch surface 446 may display virtual or soft buttons and a virtual keyboard, which may be used as an input/output device by the user.

Other input controller(s) 444 may be coupled to other input/control devices 448, such as one or more buttons, rocker switches, thumb-wheel, infrared port, USB port, and/or a pointer device such as a stylus. The one or more buttons (not shown) may include an up/down button for volume control of speaker 428 and/or microphone 430.

In some implementations, device 400 may present recorded audio and/or video files, such as MP3, AAC, and MPEG video files. In some implementations, device 400 may include the functionality of an MP3 player and may include a pin connector for tethering to other devices. Other input/output and control devices may be used.

Memory interface 402 may be coupled to memory 450. Memory 450 may include high-speed random access memory or non-volatile memory, such as one or more magnetic disk storage devices, one or more optical storage devices, or flash memory (e.g., NAND, NOR). Memory 450 may store operating system 452, such as Darwin, RTXC, LINUX, UNIX, OS X, WINDOWS, or an embedded operating system such as VxWorks. Operating system 452 may include instructions for handling basic system services and for performing hardware dependent tasks. In some implementations, operating system 452 may include a kernel (e.g., UNIX kernel).

Memory 450 may also store communication instructions 454 to facilitate communicating with one or more additional devices, one or more computers or servers, including peer-to-peer communications. Communication instructions 454 may also be used to select an operational mode or communication medium for use by the device, based on a geographic location (obtained by the GPS/Navigation instructions 468) of the device. Memory 450 may include graphical user interface instructions 456 to facilitate graphic user interface processing, including a touch model for interpreting touch inputs and gestures; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes; camera instructions 470 to facilitate camera-related processes and functions; and other instructions 472 for performing some or all of the processes, as described in reference to FIGS. 1-3.

Each of the above identified instructions and applications may correspond to a set of instructions for performing one or more functions described above. These instructions need not be implemented as separate software programs, procedures, or modules. Memory 450 may include additional instructions or fewer instructions. Furthermore, various functions of the device may be implemented in hardware and/or in software, including in one or more signal processing and/or application specific integrated circuits (ASICs).

### Example Server Architecture

FIG. 5 is a block diagram of example architecture for a server computer operated by service 114 described when referring to FIGS. 1-3. Other architectures are possible, including architectures with more or fewer components. In some implementations, architecture 500 includes one or more processors 502 (e.g., dual-core Intel® Xeon® Processors), one or more output devices 504 (e.g., LCD), one or more network interfaces 506, one or more input devices 508 (e.g., mouse, keyboard, touch-sensitive display) and one or more computer-readable mediums 512 and memory 513 (e.g., RAM, ROM, SDRAM, hard disk, optical disk, flash memory, etc.). These components can exchange communications and data over one or more communication channels 510 (e.g., buses), which can utilize various hardware and software for facilitating the transfer of data and control signals between components.

The term “computer-readable medium” refers to any medium that participates in providing instructions to processor 502 for execution, including without limitation, non-volatile media (e.g., optical or magnetic disks), volatile media (e.g., memory) and transmission media. Transmission media includes, without limitation, coaxial cables, copper wire and fiber optics.

Computer-readable mediums 512 or memory 513 can further include operating system 514 (e.g., Mac OS® server, Windows® NT server), network communication module 516, analytics module 518 and map services module 520. Operating system 514 can be multi-user, multiprocessing, multitasking, multithreading, real time, etc. Operating system 514 performs basic tasks, including but not limited to: recognizing input from and providing output to devices 508, 504; keeping track and managing files and directories on computer-readable mediums 512 and memory 513; controlling peripheral devices; and managing traffic on the one or more communication channels 510. Network communications module 516 includes various components for establishing and maintaining network connections (e.g., software for implementing communication protocols, such as TCP/IP, HTTP, etc.). Digital media library 518 stores digital media assets and object containers (e.g., playlists). Syncing service module 520 performs syncing between remote digital media library 518 and corresponding local digital media library 120 (FIG. 1) on client device 102, as described in reference to FIGS. 1-3. Syncing includes downloading digital media assets to client device 102 and storing the digital media assets in local digital media library 120.

Architecture 500 can be included in any computer device, including one or more server computers each having one or more processing cores. Architecture 500 can be implemented in a parallel processing or peer-to-peer infrastructure or on a single device with one or more processors. Software can include multiple software components or can be a single body of code.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving, by an electronic device, a notification from a digital media store regarding an update to a remote digital media library;
evaluating rules for storing digital media asset data on the electronic device;
determining, based on the evaluation of the rules, one or more digital media assets to be stored locally and are not stored locally;
initiating a download of data for the digital media assets that are not stored locally; and
storing the downloaded data on the electronic device.

2. The method of claim 1, where evaluating rules comprises:
identifying at least one container in a local digital media library that includes at least one digital media asset that is to be stored locally and that is not stored locally.

3. The method of claim 2, where the container is a playlist.

4. The method of claim 3, where the playlist includes digital media assets that are most frequently played.

5. The method of claim 3, where the playlist includes digital media assets associated with a specific artist.

6. The method of claim 3, where the playlist includes digital media assets that are rated higher than other digital media assets in the local digital media library.

7. The method of claim 1, where the update to the remote digital media library includes adding a new digital media asset to the remote digital media library.

8. The method of claim 1, where initiating a download further comprises:
aggregating requests for digital media asset data; and
sending the aggregated requests to the digital media store.

9. The method of claim 1, where the rules are specific to a type of electronic device.

10. The method of claim 1, where at least one of the rules is based on input provided by a user of the electronic device.

11. A system comprising:
one or more processors;
memory coupled to the one or more processors and configured to store instructions, which, when executed by the one or more processors, causes the one or more processors to perform operations comprising:
receiving, by an electronic device, a notification from a digital media store regarding an update to a remote digital media library;
evaluating rules for storing digital media asset data on the electronic device;
determining, based on the evaluation of the rules, one or more digital media assets that are to be stored locally and are not stored locally;
initiating a download of data for the digital media assets that are not stored locally; and
storing the downloaded data on the electronic device.

12. The system of claim 11, where evaluating rules comprises:
identifying at least one container in a local digital media library that includes at least one digital media asset that is to be stored locally and that is not stored locally.

13. The system of claim 12, where the container is a playlist.

14. The system of claim 13, where the playlist includes digital media assets that are most frequently played.

15. The system of claim 13, where the playlist includes digital media assets associated with a specific artist.

16. The system of claim 13, where the playlist includes digital media assets that are rated higher than other digital media assets in the local digital media library.

17. The system of claim 11, where the update to the remote digital media library includes adding a new digital media asset to the remote digital media library.

18. The system of claim 11, where initiating a download further comprises:
aggregating requests for digital media asset data; and
sending the aggregated requests to the digital media store.

19. The system of claim 11, where the rules are specific to a type of electronic device.

20. The system of claim 11, where at least one of the rules is based on input provided by a user of the electronic device.
